(19) United States
(12) Patent Application Publication
(10) Pub. No.: US 2015/0177836 A1
(43) Pub. Date: Jun. 25, 2015

(54) WEARABLE INFORMATION INPUT DEVICE, INFORMATION INPUT SYSTEM, AND INFORMATION INPUT METHOD

(71) Applicant: KABUSHIKI KAISHA TOSHIBA, Tokyo (JP)

(72) Inventors: Kazushige OUCHI, Saitama (JP); Yasunobu YAMAUCHI, Yokohama (JP); Tsukasa IKE, Tokyo (JP); Toshiaki NAKASU, Tokyo (JP)

(21) Appl. No.: 14/574,608

(22) Filed: Dec. 18, 2014

(30) Foreign Application Priority Data
Dec. 24, 2013 (JP) 2013-265827

(51) Int. Cl. G06F 3/01

(52) U.S. Cl. CPC G06F 3/014

(57) ABSTRACT

A wearable information input device according to an embodiment is worn on an upper limb of a user. The wearable information input device includes a contact detecting unit, a position detecting unit, and a trajectory generating unit. The contact detecting unit detects contact with the upper limb by an input unit. The input unit is used by the user to input information. The position detecting unit detects a position of the input unit while the input unit is in contact with the upper limb. The trajectory generating unit generates a trajectory of motion of the input unit based on information about the position detected by the position detecting unit.

### CROSS REFERENCE TO RELATED APPLICATION(S)

This application is based upon and claims the benefit of priority from the prior Japanese Patent Application No. 2013-265827, filed on Dec. 24, 2013, the entire contents of which are incorporated herein by reference.

### FIELD

Embodiments described herein relate generally to a wearable information input device, an information input system, and an information input method.

### BACKGROUND

As a device that is attached to a body part and is used to input information, there has been a wristwatch-type input device that detects impact or acceleration accompanying tapping actions of fingertips on a desired supporting object, and constructs a command or characters based on the correlation among the timings to tap respective fingers obtained as a result of the detection. To input a command or characters with such an input device, a user has to store the timings to tap the respective fingers and the correlation among the timings into the input device in advance.

### BRIEF DESCRIPTION OF THE DRAWINGS

FIG. 1 is a block diagram showing the functional structure of a wearable information input device according to a first embodiment;

FIG. 2 is a diagram showing an example of use of the wearable information input device shown in FIG. 1;

FIG. 3 is a diagram showing a specific example structure of the wearable information input device shown in FIG. 1;

FIG. 4 is a diagram for explaining an example of a finger position detection method;

FIG. 5 is a diagram showing another example of use of the wearable information input device shown in FIG. 1;

FIG. 6 is a diagram showing yet another example of use of the wearable information input device shown in FIG. 1;

FIG. 7 is a flowchart showing an example operation of the wearable information input device shown in FIG. 1;

FIG. 8 is a block diagram showing the functional structure of a wearable information input device according to a second embodiment;

FIG. 9 is a diagram showing a specific example structure of the wearable information input device shown in FIG. 8;

FIG. 10 is a diagram showing an example of use of the wearable information input device shown in FIG. 8;

FIG. 11 is a block diagram showing the functional structure of a wearable information input device according to a third embodiment;

FIG. 12 is a diagram showing an example of use of the wearable information input device shown in FIG. 11;

FIG. 13 is a diagram showing another example of use of the wearable information input device shown in FIG. 11;

FIG. 14 is a diagram showing yet another example of use of the wearable information input device shown in FIG. 11;

FIG. 15 is a diagram showing still another example of use of the wearable information input device shown in FIG. 11;

FIG. 16 is a block diagram showing the functional structure of an information input system that includes a wearable information input device according to a fourth embodiment;

FIG. 17 is a block diagram showing the functional structure of another information input system that includes a wearable information input device according to the fourth embodiment; and

FIG. 18 is a block diagram showing the functional structure of an information input system that includes a wearable information input device according to a fifth embodiment.

### DETAILED DESCRIPTION

Embodiments will now be explained with reference to the accompanying drawings. The present invention is not limited to the embodiments.

A wearable information input device according to an embodiment is worn on an upper limb of a user. The wearable information input device includes a contact detecting unit, a position detecting unit, and a trajectory generating unit. The contact detecting unit detects contact with the upper limb by an input unit. The input unit is used by the user to input information. The position detecting unit detects a position of the input unit while the input unit is in contact with the upper limb. The trajectory generating unit generates a trajectory of motion of the input unit based on information about the position detected by the position detecting unit.

The following is a description of embodiments of wearable information input devices, with reference to the accompanying drawings. In the description below, a wearable information input device is attached to a wrist of a user, and a finger of the hand on the opposite side from the wrist having the wearable information input device attached thereto is used as the input unit. However, a wearable information input device of any of the embodiments described below can be attached to any part of an upper limb of a user. Also, any part of the upper limb on the opposite side from the wrist having a wearable information input device attached thereto can be used as the input unit. The input unit may be a stylus pen, for example.

### First Embodiment

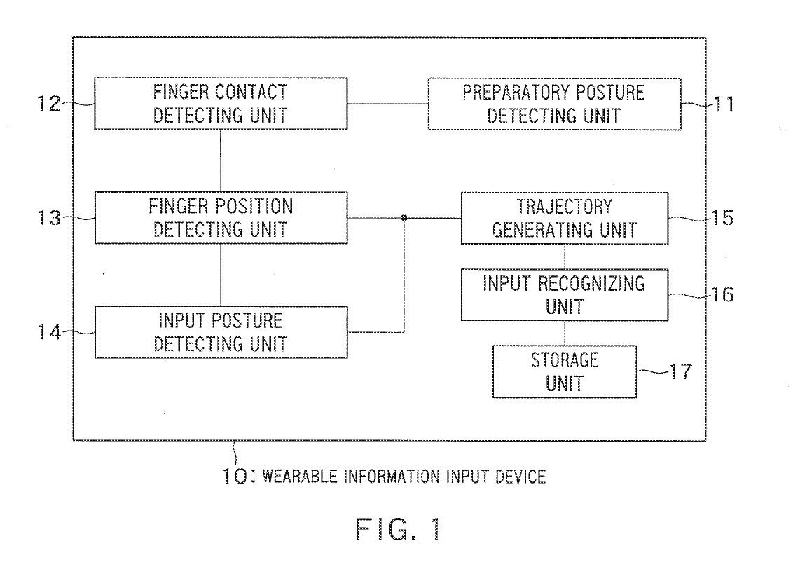

Referring to FIGS. 1 through 7, a wearable information input device according to a first embodiment is described below. The wearable information input device according to this embodiment is a storage device that stores information input by a user. The user inputs information by putting a finger of the other hand onto the skin around the wrist having the wearable information input device attached thereto, and performing a predetermined operation with the finger. The user can use the wearable information input device of this embodiment as a notebook or a notepad, for example.

FIG. 1 is a block diagram showing the functional structure of the wearable information input device 10 according to this embodiment. As shown in FIG. 1, the wearable information input device 10 according to this embodiment includes a preparatory posture detecting unit 11 that detects a preparatory posture, a finger contact detecting unit 12 that detects finger contact, a finger position detecting unit 13 that detects a position of a finger, an input posture detecting unit 14 that detects an input posture, a trajectory generating unit 15 that generates a trajectory of a finger, an input recognizing unit 16 that recognizes input contents, and a storage unit 17 that stores input contents.

The preparatory posture detecting unit 11 detects a preparatory posture. A preparatory posture is the posture of the upper limb having the wearable information input device 10 attached thereto when the user inputs information. As the wearable information input device 10 is attached to the wrist of the user, the posture of the upper limb having the wearable information input device 10 attached thereto is substantially the same as the posture of the wearable information input device 10. Accordingly, the preparatory posture detecting unit 11 can detect a preparatory posture by detecting the posture (tilt) of the wearable information input device 10.

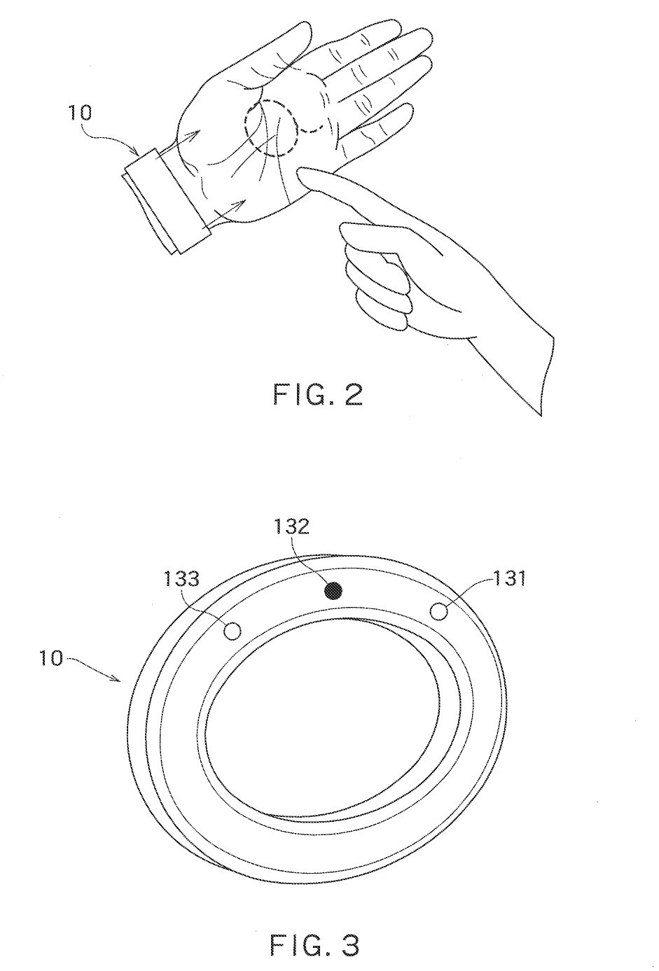

FIG. 2 is a diagram showing an example of use of the wearable information input device 10. When the user inputs information, the user is expected to take a predetermined preparatory posture as shown in FIG. 2, for example. The preparatory posture detecting unit 11 detects the posture (tilt) of the wearable information input device 10 constantly or at predetermined time intervals, and compares the detected posture with a prerecorded preparatory posture (tilt), to determine whether the wearable information input device 10 is in a preparatory posture. When the posture of the wearable information input device 10 matches the prerecorded preparatory posture, the preparatory posture detecting unit 11 determines that the user is in a preparatory posture. In this manner, the preparatory posture detecting unit 11 detects a preparatory posture.

So as to detect the posture (tilt) of the wearable information input device 10, the preparatory posture detecting unit 11 includes an acceleration sensor, a geomagnetic sensor, an angular velocity sensor, or the like. In a case where the preparatory posture detecting unit 11 detects a preparatory posture with an acceleration sensor, the acceleration sensor is preferably a triaxial acceleration sensor. The preparatory posture detecting unit 11 may detect a preparatory posture by monitoring acceleration in the direction of gravitational acceleration, for example.

The preparatory posture detecting unit 11 may also analyze changes in posture prior to a preparatory posture by using a technique such as DP (Dynamic Programming) matching or machine learning, to detect a preparatory operation the user has performed before taking the preparatory posture. Alternatively, the wearable information input device 10 may not include the preparatory posture detecting unit 11.

The finger contact detecting unit 12 detects contact of a finger with the skin in the vicinity of the wrist to which the wearable information input device 10 is attached. The finger contact detecting unit 12 may detect finger contact by any appropriate conventional method.

For example, the finger contact detecting unit 12 can detect finger contact by detecting a change in capacitance when a finger contacts with the skin in the vicinity of the wrist. In this case, so as to detect capacitance, the finger contact detecting unit 12 is preferably designed to include an electrode that is located on the wrist side of the wearable information input device 10.

The finger contact detecting unit 12 can also detect finger contact by detecting a change in light intensity when a finger contacts with the skin in the vicinity of the wrist, for example. In this case, the finger contact detecting unit 12 is preferably designed to include a light emitting device such as an LED, and a light receiving device such as a photodiode that receives light that is emitted from the light emitting device and is then reflected.

Also, the finger contact detecting unit 12 may include an imaging unit, and detect finger contact by analyzing an image of an area in the vicinity of the wrist, the image being captured by the imaging unit.

When a preparatory posture is detected by the preparatory posture detecting unit 11, the finger contact detecting unit 12 detects finger contact. With this structure, information is not input in a case where an input unit such as a finger contacts with the skin in the vicinity of the wrist when a posture other than a preparatory posture is detected. Accordingly, inadvertent input due to inadvertent contact of the input unit with the skin in the vicinity of the wrist can be prevented. As the finger contact detecting unit 12 does not operate before a preparatory posture is detected, power consumption by the wearable information input device 10 can be reduced.

In a case where the wearable information input device 10 does not include the preparatory posture detecting unit 11, the finger contact detecting unit 12 detects finger contact constantly or at predetermined time intervals. In this case, the user can input information even in a posture other than a preparatory posture.

The finger position detecting unit 13 detects a position of the finger while finger contact is detected by the finger contact detecting unit 12. The position of the finger detected by the finger position detecting unit 13 is the position of the finger on a plane that is substantially parallel to the portion of the skin with which the finger contacts so as to input information. The finger position detecting unit 13 can detect the position of the finger by any appropriate conventional method.

For example, the finger position detecting unit 13 may be designed to include at least two light emitting devices arranged at a predetermined interval, and a light receiving device that receives light emitted from the light emitting devices. FIG. 3 is a diagram showing a specific example structure of the wearable information input device 10. In the wearable information input device 10 shown in FIG. 3, the finger contact detecting unit 12 is designed to include two LEDs 131 and 133 arranged at a predetermined interval, and a photodiode 132 that receives light beams that are emitted from the LEDs 131 and 133 and are then reflected, and detects the intensities of the light beams. As shown in FIG. 3, the LEDs 131 and 133 and the photodiode 132 are located on a side surface of the wearable information input device 10.

In the finger position detecting unit 13 having such a structure, the LEDs 131 and 133 alternately emit light at predetermined time intervals (time-sharing light emission), and, at predetermined sampling intervals, the photodiode 132 detects the intensities of light beams that are emitted from the LEDs 131 and 133 and are then reflected. The sampling intervals are preferably synchronized with the time-sharing light emission. Accordingly, the photodiode 132 can detect the intensity of reflected light of the LED 131 and the intensity of reflected light of the LED 133 at the predetermined sampling intervals.

The intensities of light beams that are emitted from the respective LEDs and are then reflected vary with the distances from the respective LEDs to the finger, and accordingly, the distances from the respective LEDs to the finger can be modeled in accordance with the intensities of reflected light beams. Accordingly, the finger position detecting unit 13 can detect the position of the finger by comparing the intensity of reflected light of each LED detected by the photodiode 132 with the modeled distance from each corresponding LED.

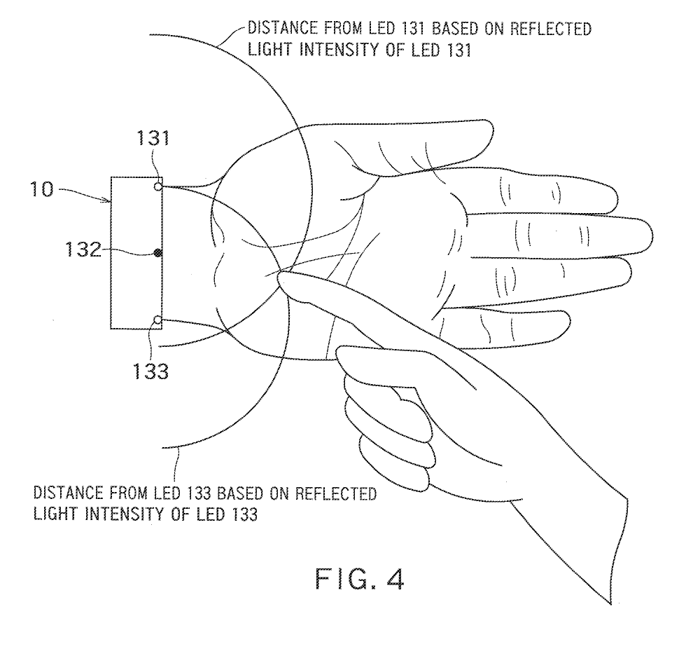

FIG. 4 is a diagram for explaining this finger position detection method. As shown in FIG. 4, the finger position detecting unit 13 can detect the position of a finger on a plane by detecting distances from the respective LEDs. In a case where the LEDs 131 and 133 are made to perform time-sharing light emission as described above, the wavelengths of light beams emitted from the respective LEDs may be the same or may differ from each other. Where the wavelengths of light beams emitted from the LEDs 131 and 133 differ from each other, the finger position detecting unit 13 may cause the LEDs 131 and 133 to emit light at the same time. In this case, the photodiode 132 is formed with two elements that are sensitive to the wavelength of the LED 131 and the wavelength of the LED 133, and detects the respective intensities of received reflected light beams. In this manner, the intensity of reflected light from each LED can be detected. Thus, the finger position detecting unit 13 can detect the position of a finger.

The finger position detection method implemented by the finger position detecting unit 13 is not limited to the above described method. For example, the finger position detecting unit 13 can detect the position of a finger by analyzing an image of the finger captured by an imaging unit such as a camera.

The input posture detecting unit 14 detects an input posture. An input posture is the posture (tilt) of the upper limb having the wearable information input device 10 attached thereto while the user is inputting information or while finger contact is detected by the finger contact detecting unit 12. As the wearable information input device 10 is attached to the wrist of the user, the posture of the upper limb having the wearable information input device 10 attached thereto is substantially the same as the posture of the wearable information input device 10. Accordingly, the input posture detecting unit 14 can detect an input posture by detecting the posture (tilt) of the wearable information input device 10. While finger contact is detected by the finger contact detecting unit 12, the input posture detecting unit 14 detects the posture of the wearable information input device 10 constantly or at predetermined sampling intervals.

So as to detect the posture (tilt) of the wearable information input device 10, the input posture detecting unit 14 includes an acceleration sensor, a geomagnetic sensor, an angular velocity sensor, or the like. In a case where the input posture detecting unit 14 detects a posture with an acceleration sensor, the acceleration sensor is preferably a triaxial acceleration sensor. The input posture detecting unit 14 may share the means to detect the posture of the wearable information input device 10 with the preparatory posture detecting unit 11. Alternatively, the wearable information input device 10 may not include the input posture detecting unit 14.

The trajectory generating unit 15 generates a trajectory of motion of a finger based on information about the position of the finger detected by the finger position detecting unit 13. The trajectory generating unit 15 acquires information about successive finger positions detected between the start and the end of finger position detection by the finger position detecting unit 13, and generates a trajectory of the finger by arranging the acquired position information in chronological order.

Based on information about the trajectory of the finger generated by the trajectory generating unit 15, the input recognizing unit 16 recognizes input contents that have been input by the user. The input contents include a handwritten character, a cursor operation (a cursor movement or a click), a gesture such as a flicking action, or the like.

For example, in a case where the input contents include a character, the input recognizing unit 16 performs character recognition, and recognizes the input character. In a case where the input character has one stroke, the input recognizing unit 16 can recognize the input character at the same time as the acquisition of the trajectory information from the trajectory generating unit 15. In a case where a character with two or more strokes is input, the input recognizing unit 16 is unable to correctly recognize the input contents from a single piece of trajectory information. Therefore, the input recognizing unit 16 temporarily stores trajectory information acquired from the trajectory generating unit 15, and recognizes the input contents based on more than one piece of stored trajectory information. For example, the input recognizing unit 16 temporarily stores trajectory information acquired since the start of an input of a character, and determines that the input of one character has been completed when the duration of a finger non-contact state detected by the finger contact detecting unit 12 becomes equal to or longer than a predetermined value. The input recognizing unit 16 then recognizes the input contents based on the trajectory information acquired so far. Such a method for correctly recognizing input contents from a handwritten input can be selected from appropriate conventional methods.

In a case where the input contents include a cursor operation, the input recognizing unit 16 performs pointing recognition, to recognize the input cursor operation. In a case where finger contact in the vicinity of a finger position detected immediately before a finger non-contact state is detected is detected within a predetermined period of time after the finger contact detecting unit 12 detects the finger non-contact state, the input recognizing unit 16 may recognize a click. A double click can be recognized in the same manner as above.

In a case where the input contents include a gesture, the input recognizing unit 16 performs gesture recognition, to recognize the input gesture. The gesture may be a flicking action.

The method of recognition to be performed by the input recognizing unit 16, such as character recognition, gesture recognition, or pointing recognition, may be the same as a conventional method using a touch pad, a mouse, or a pointing device, or may be a uniquely developed method. The type of input contents (a character, a gesture, a cursor operation, or the like) may be determined by the input recognizing unit 16 based on trajectory information or the like, or may be designated by a user operation.

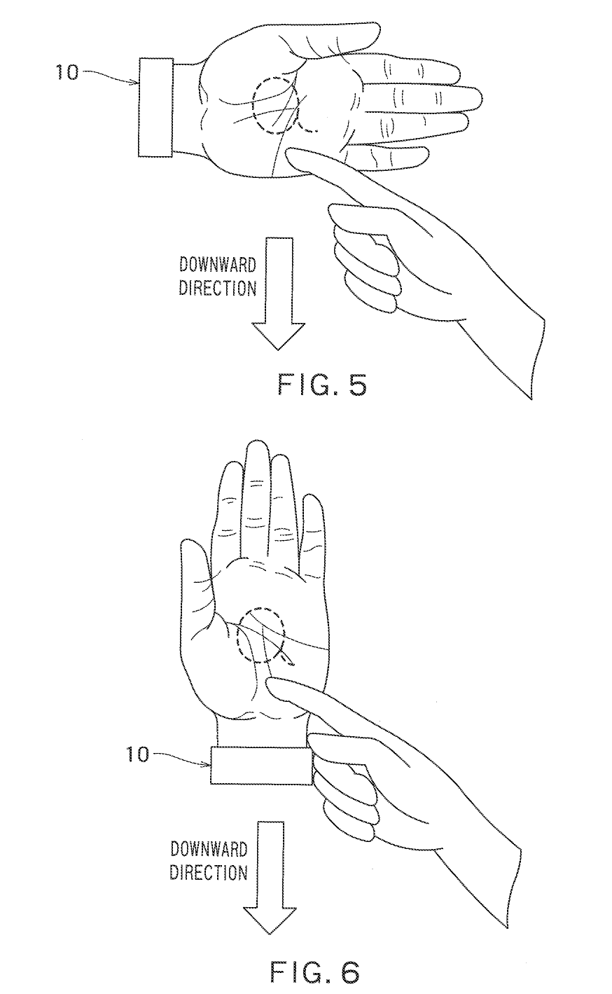

The input recognizing unit 16 also recognizes input contents based on an input posture detected by the input posture detecting unit 14. For example, the input recognizing unit 16 sets the downward direction (or upward direction) in a finger trajectory based on input posture information acquired from the input posture detecting unit 14. FIGS. 5 and 6 are diagrams each showing an example of use of the wearable information input device 10. As shown in FIG. 5, in a case where the user inputs information with the palm in a horizontal state (where the wearable information input device 10 is in a vertical state), the input recognizing unit 16 sets the direction toward the little finger (the direction indicated by the arrow in FIG. 5) as the downward direction of a finger trajectory based on input posture information. As shown in FIG. 6, in a case where the user inputs information with the palm in a vertical state (where the wearable information input device 10 is in a horizontal state), the input recognizing unit 16 sets the direction toward the wrist (the direction indicated by the arrow in FIG. 5) as the downward direction of a finger trajectory based on input posture information.

By setting the downward direction (or the upward direction) of a trajectory and recognizing input contents, the input recognizing unit 16 can recognize the input contents that the user has intended. The input recognizing unit 16 may also have a mode for fixing the downward direction of a finger trajectory to a predetermined direction or a direction designated by the user while recognizing input contents. By using this mode, the input recognizing unit 16 can recognize input contents that the user has intended, even if the user has input the information while lying down.

In a case where the wearable information input device 10 does not include the input posture detecting unit 14, the input recognizing unit 16 recognizes input contents from trajectory information, with a predetermined direction being set as the downward direction (or the upward direction).

The storage unit 17 stores input contents recognized by the input recognizing unit 16. The input contents stored in the storage unit 17 can be output by any appropriate conventional method. For example, the wearable information input device 10 may be connected to an external device in a wired or wireless manner, and input contents may be output to the external device.

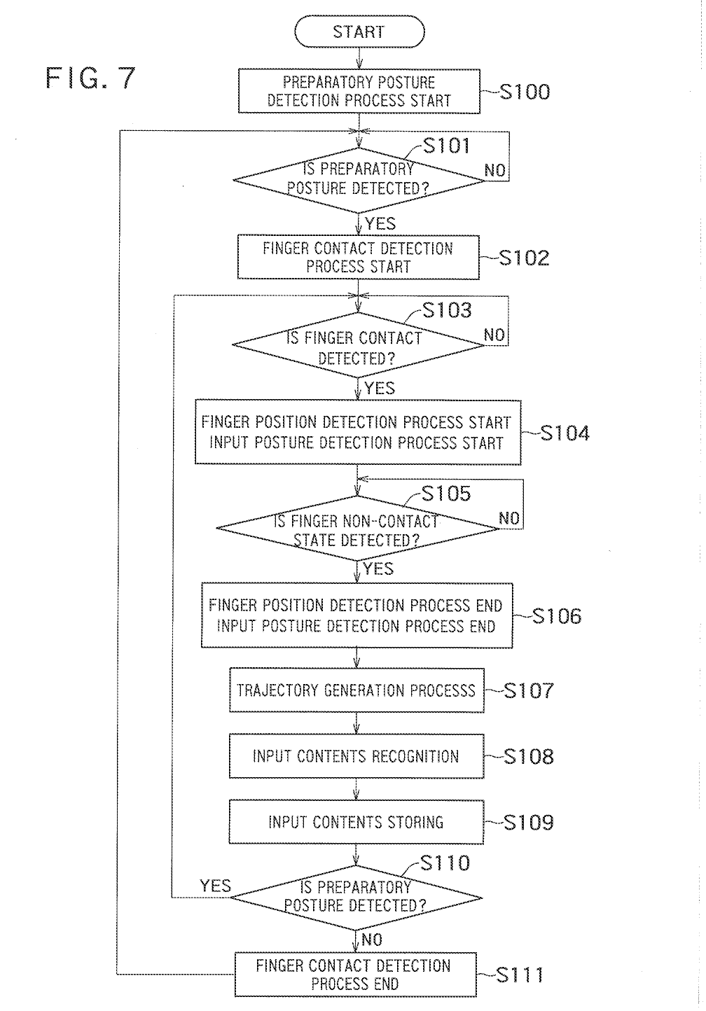

Referring now to FIG. 7, an operation of the wearable information input device 10 according to this embodiment is described. FIG. 7 is a flowchart showing an example operation of the wearable information input device 10 according to this embodiment. In the example case described below, the preparatory posture detecting unit 11 includes an acceleration sensor, the finger contact detecting unit 12 includes a capacitance sensor, the finger position detecting unit 13 includes the LEDs 131 and 133 and the photodiode 132 shown in FIG. 3, the input posture detecting unit 14 includes an acceleration sensor, the wearable information input device 10 is attached to a wrist in a wristwatch-like manner, and the user inputs information to the palm of the hand on the side having the wearable information input device 10 attached thereto, by using a finger of the other hand. As mentioned above, however, the structures of the respective components, the site to which the wearable information input device 10 is attached, and the input unit are not limited to those described above.

First, the preparatory posture detecting unit 11 starts a preparatory posture detection process to detect a preparatory posture when the user wearing the wearable information input device 10 inputs information to the palm (step S100). The preparatory posture detection process is started when the power supply to the wearable information input device 10 is switched on, for example. Alternatively, in a case where the wearable information input device 10 has a switch that controls switching on and off of the preparatory posture detection process, the preparatory posture detecting unit 11 starts the preparatory posture detection process when the switch is turned on. The preparatory posture detecting unit 11 ends the preparatory posture detection process when the power supply to the wearable information input device 10 is switched off, or when the switch is turned off.

After starting the preparatory posture detection process, the preparatory posture detecting unit 11 detects the posture of the wearable information input device 10 constantly or at predetermined time intervals until the preparatory posture detection process comes to an end, and performs a preparatory posture detection determination by comparing the detected posture of the wearable information input device 10 with a predetermined preparatory posture (step S101). The preparatory posture detecting unit 11 detects the posture of the wearable information input device 10 by monitoring acceleration in the direction of gravitational acceleration, for example. When the posture of the wearable information input device 10 matches the predetermined preparatory posture, the preparatory posture detecting unit 11 determines that the user is in a preparatory posture.

When the preparatory posture detecting unit 11 determines that the user is in a preparatory posture, or when the preparatory posture detecting unit 11 detects a preparatory posture (Yes in step S101), the finger contact detecting unit 12 starts a finger contact detection process to detect contact of a finger of the user with the palm (step S102). As the finger contact detection process is performed when a preparatory posture is detected by the preparatory posture detecting unit 11, inadvertent input is prevented, and power consumption can be reduced.

After starting the finger contact detection process, the finger contact detecting unit 12 detects capacitance with the capacitance sensor constantly or at predetermined sampling intervals until the finger contact detection process comes to an end, and performs a finger contact detection determination based on the detected capacitance (step S103). The finger contact detection determination can be performed by comparing the detected capacitance with a predetermined capacitance or detecting a change in the detected capacitance.

In a case where the wearable information input device 10 does not include the preparatory posture detecting unit 11, the finger contact detecting unit 12 starts the finger contact detection process when the power supply to the wearable information input device 10 is switched on. Alternatively, in a case where the wearable information input device 10 has a switch that controls switching on and off of the finger contact detection process, the finger contact detecting unit 12 starts the finger contact detection process when the switch is turned on.

When the finger contact detecting unit 12 detects finger contact (Yes in step S103), the finger position detecting unit 13 starts a finger position detection process to detect the position of the finger of the user, and the input posture detecting unit 14 starts an input posture detection process to detect an input posture (step S104). After starting the finger position detection process, the finger position detecting unit 13 detects a position of the finger of the user constantly or at predetermined sampling intervals until the finger position detection process comes to an end, and transmits information about detected finger positions to the trajectory generating unit 15. Likewise, after starting the input posture detection process, the input posture detecting unit 14 detects an input posture constantly or at predetermined sampling intervals until the input posture detection process comes to an end, and transmits information about the detected input posture to the trajectory generating unit 15. The input posture detecting unit 14 may also transmit the input posture information to the input recognizing unit 16.

If the finger contact detecting unit 12 detects a finger non-contact state or an event that the finger comes off the palm after detecting the finger contact (Yes in step S105), the finger position detecting unit 13 ends the finger position detection process, and the input posture detecting unit 14 ends the input posture detection process (step S106). Based on the information about the series of finger positions received from the finger position detecting unit 13 while the finger contact detecting unit 12 detects finger contact, the trajectory generating unit 15 generates a trajectory of motion of the finger in contact with the palm (step S107). The trajectory generating unit 15 transmits the generated trajectory information and the input posture information received from the input posture detecting unit 14, to the input recognizing unit 16.

Based on the trajectory information and the input posture information received from the trajectory generating unit 15, the input recognizing unit 16 recognizes input contents that have been input by the user (step S108). For example, the input recognizing unit 16 can recognize a gesture such as a flicking action through gesture recognition. The input recognizing unit 16 can also recognize an input character through character recognition. The input recognizing unit 16 can also recognize a cursor operation through pointing recognition. The input recognizing unit 16 transmits the recognized input contents to the storage unit 17.

The storage unit 17 stores the input contents transmitted from the input recognizing unit 16 (step S109). The input contents stored in the storage unit 17 can be output to an external device by using a wired or wireless communication or a USB (Universal Serial Bus).

If the user remains in a preparatory posture even or a preparatory posture is still detected by the preparatory posture detecting unit 11 after the user removes the finger from the palm (Yes in step S110), it is considered that the input by the user has not ended. Therefore, the finger contact detecting unit 12 continues the finger contact detection process (step S103).

If the user is not in a preparatory posture or a preparatory posture is not detected by the preparatory posture detecting unit 11 after the user removes the finger from the palm (No in step S110), it is considered that the input by the user has ended. Therefore, the finger contact detecting unit 12 ends the finger contact detection process (step S111). After the finger contact detecting unit 12 ends the finger contact detection process, the preparatory posture detecting unit 11 continues the preparatory posture detection process (step S101) until the power supply to the wearable information input device 10 is switched off, for example.

As described above, with the wearable information input device 10 according to this embodiment, a user can input a character by writing the character on a palm, and can input a gesture or a cursor operation by moving a finger on a palm.

Accordingly, the user can input information through these intuitive actions. Also, the user does not need to store timings to tap respective fingers for inputting information and the correlation among the timings in advance. Thus, the user can readily input information.

### Second Embodiment

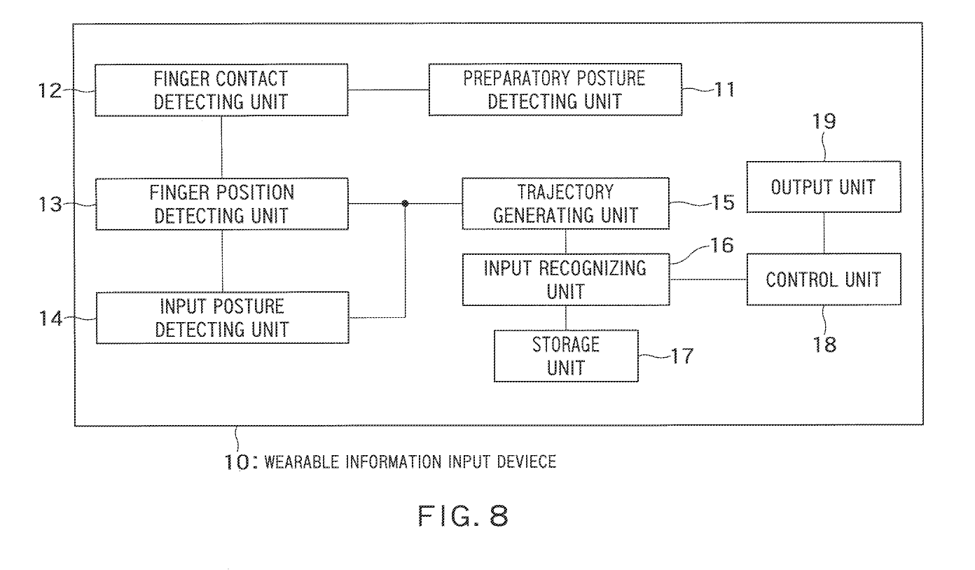

Referring now to FIGS. 8 through 10, a wearable information input device according to a second embodiment is described. The wearable information input device according to this embodiment can store and output information that has been input by a user. Accordingly, the user can check the information that has been input to and stored into the wearable information input device, without the use of any external device.

FIG. 8 is a block diagram showing the functional structure of the wearable information input device 10 according to this embodiment. As shown in FIG. 8, the wearable information input device 10 according to this embodiment includes a preparatory posture detecting unit 11, a finger contact detecting unit 12, a finger position detecting unit 13, an input posture detecting unit 14, a trajectory generating unit 15, an input recognizing unit 16, and a storage unit 17. The above components are the same as those of the first embodiment. The wearable information input device 10 according to this embodiment further includes a control unit 18 and an output unit 19.

The control unit 18 generates a control signal for the wearable information input device 10 in accordance with input contents recognized by the input recognizing unit 16. In a case where a character is input, the control unit 18 generates a control signal for causing the output unit 19 to output the input character. In a case where a cursor operation is input, the control unit 18 generates a control signal for operating the cursor displayed on the output unit 19 in accordance with the input cursor operation. In a case where a gesture is input, the control unit 18 generates a control signal for changing the output from the output unit 19 in accordance with the input gesture.

The output unit 19 outputs a result of control in accordance with a control signal generated by the control unit 18. In a case where the control unit 18 generates a control signal for displaying input contents, the input contents are displayed on the output unit 19. Any appropriate conventional output device can be used as the output unit 19. For example, the output unit 19 may be a display that outputs information as an image, or may be a speaker that outputs information as sound. The output unit 19 may be a vibration motor that outputs information as vibration.

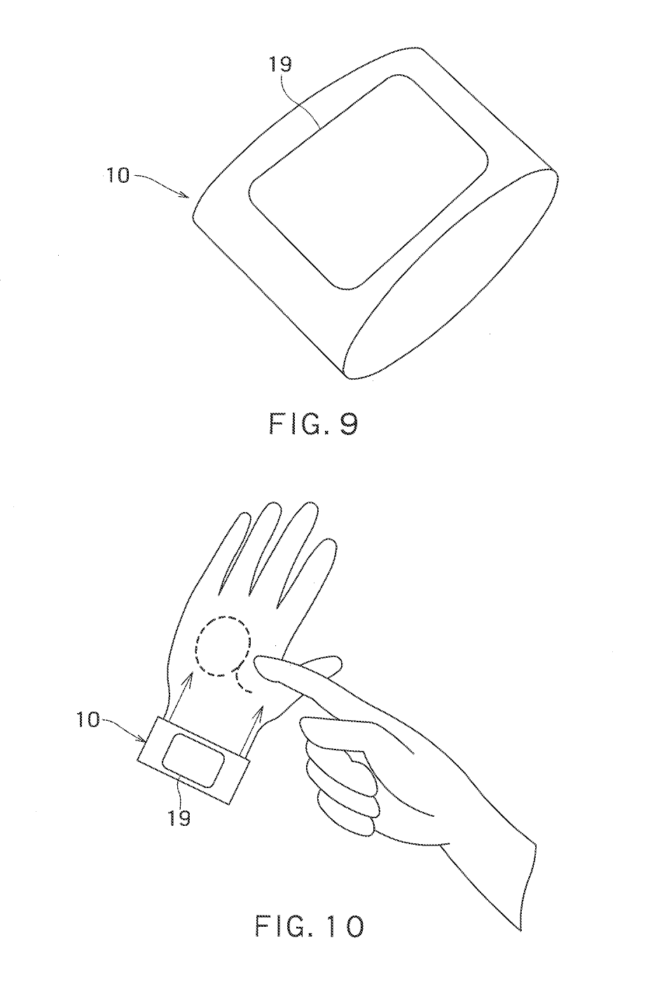

FIG. 9 is a diagram showing a specific example structure of the wearable information input device 10 according to this embodiment. In FIG. 9, the output unit 19 is a display that outputs information as an image. In such a wearable information input device, the control unit 18 causes the output unit 19 to display an input character when text information is input. When a cursor operation is input, the control unit 18 operates the cursor displayed on the output unit 19 in accordance with the input cursor operation. When a gesture is input, the control unit 18 changes the displayed contents in accordance with the input gesture.

For example, when a horizontal/vertical flicking action is input, the control unit 18 generates a control signal for sliding and switching displayed screens of the output unit 19. In the wearable information input device 10 having the output unit 19 as a display, the output unit 19 may display the time. In this case, the user can also use the wearable information input device 10 as a wristwatch. Alternatively, the functional structure of the wearable information input device 10 may be incorporated into a wristwatch.

In the wearable information input device 10 having the output unit 19 as a display as shown in FIG. 9, the input recognizing unit 16 can select a recognition method in accordance with a state of the output unit 19. For example, when a text box for inputting or displaying characters is active in the output unit 19, the input recognizing unit 16 selects character recognition. When a cursor is active in the output unit 19, the input recognizing unit 16 selects pointing recognition. In any other cases, the input recognizing unit 16 selects gesture recognition. This switching of recognition methods in the input recognizing unit 16 can be realized by the input recognizing unit 16 acquiring a state of the output unit 19. Alternatively, the control unit 18 may transmit a control signal for switching recognition methods in the input recognizing unit 16 in accordance with a state of the output unit 19.

FIG. 10 is a diagram showing an example of use of the wearable information input device 10 according to this embodiment. As shown in FIG. 10, the user can wear the wearable information input device 10 so that the output unit 19 is positioned on the side of the back of the hand. In this case, the user can input information to the back of the hand with a finger of the other hand. The user may of course wear the wearable information input device 10 so that the output unit 19 is positioned on the side of the palm of the hand.

As described above, with the wearable information input device 10 according to this embodiment, a user can cause the output unit 19 to output information that has been input to or stored into the wearable information input device 10, and check the information without the use of any external device.

### Third Embodiment

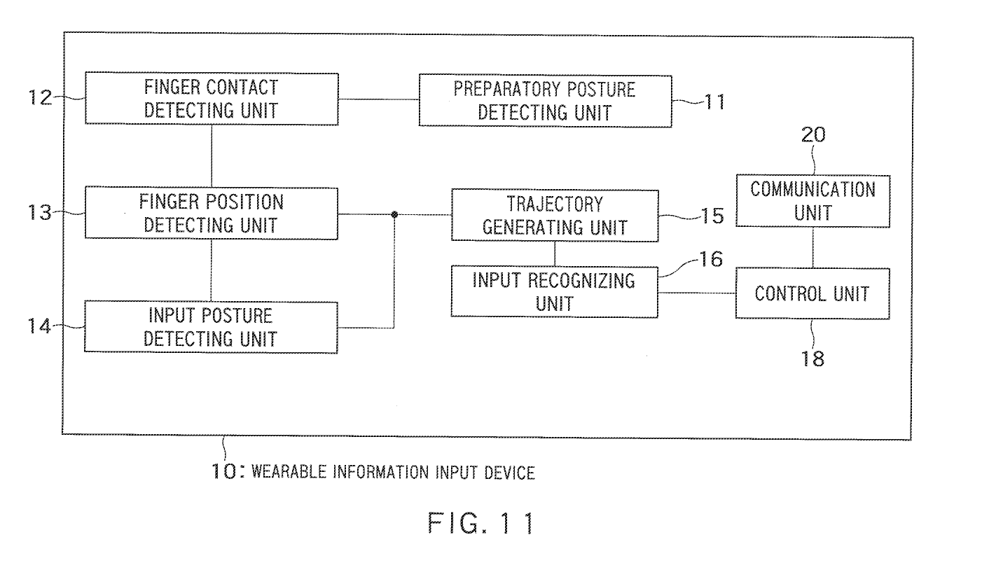

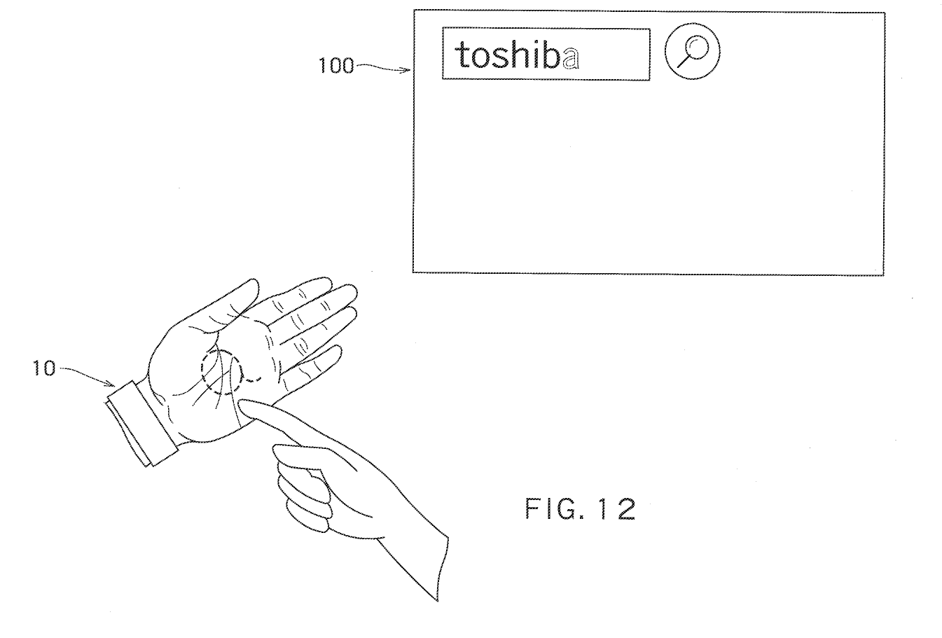

Referring now to FIGS. 11 through 15, a wearable information input device according to a third embodiment is described. In this embodiment, the wearable information input device operates an external device in accordance with the contents of an input from the user. The user can use the wearable information input device as an input unit for an external device having a communication function.

FIG. 11 is a diagram showing the functional structure of the wearable information input device 10 according to this embodiment. As shown in FIG. 11, the wearable information input device 10 according to this embodiment includes a preparatory posture detecting unit 11, a finger contact detecting unit 12, a finger position detecting unit 13, an input posture detecting unit 14, a trajectory generating unit 15, and an input recognizing unit 16. The above components are the same as those of the foregoing embodiments. The wearable information input device 10 according to this embodiment further includes a control unit 18 and a communication unit 20.

The control unit 18 generates a control signal for operating an external device in accordance with input contents recognized by the input recognizing unit 16. In a case where a character is input, the control unit 18 generates a control signal for causing an external device to output the input character. In a case where a cursor operation is input, the control unit 18 generates a control signal for operating the cursor displayed on an external device in accordance with the input cursor operation. In a case where a gesture is input, the control unit 18 generates a control signal for changing the output from an external device in accordance with the input gesture. It should be noted that the control unit 18 may generate a control signal for the wearable information input device 10 in accordance with input contents recognized by the input recognizing unit 16, as in the second embodiment.

The communication unit 20 communicates with an external device having a communication function, and transmits a control signal generated by the control unit 18 to the external device. The communication unit 20 may be a wireless communication means such as Bluetooth™, Wi-Fi™, ZigBee™, or infrared rays, or may be a cable communication means. Via the communication unit 20, the wearable information input device 10 can communicate with an external device having a communication function and an output function, such as a PC, a television receiver, a smartphone, a tablet PC, an eyeglass-type wearable device, a digital signage device, a projector connected to a screen, or an audio device. The wearable information input device 10 is associated (paired) with one or more external devices, and a control signal is transmitted to an associated external device.

FIGS. 12 through 15 are diagrams each showing an example of use of the wearable information input device 10 according to this embodiment. As shown in FIG. 12, the user can use the wearable information input device 10 to input characters to a text box of an external device 100 associated with the wearable information input device 10. When the user inputs text information by using the wearable information input device 10, the control unit 18 generates a control signal for causing the external device 100 to display the input characters, and the generated control signal is transmitted to the external device 100 via the communication unit 20. Based on the received control signal, the external device 100 displays the input characters in the text box. The user can also use the wearable information input device 10 to perform an operation such as a search by inputting characters to the external device 100.

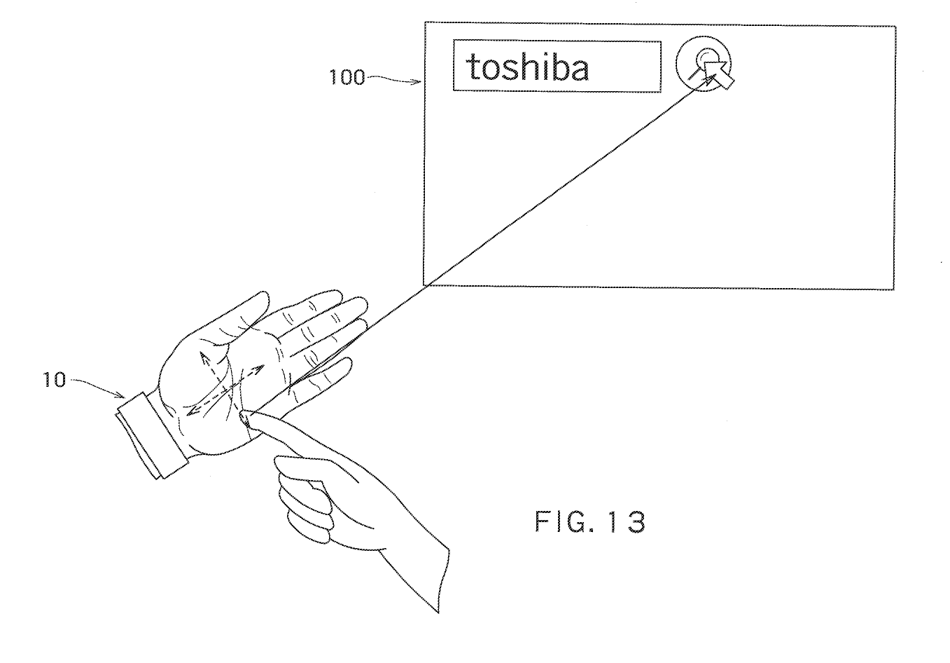

As shown in FIG. 13, the user can also use the wearable information input device 10 to operate the cursor displayed on an external device 100 associated with the wearable information input device 10. For example, when the user inputs a cursor operation (a cursor movement) by using the wearable information input device 10, the control unit 18 generates a control signal for moving the cursor displayed on the external device 100, and the generated control signal is transmitted to the external device 100 via the communication unit 20. The external device 100 moves the cursor based on the received control signal. As described above, the user can also perform a click with the cursor.

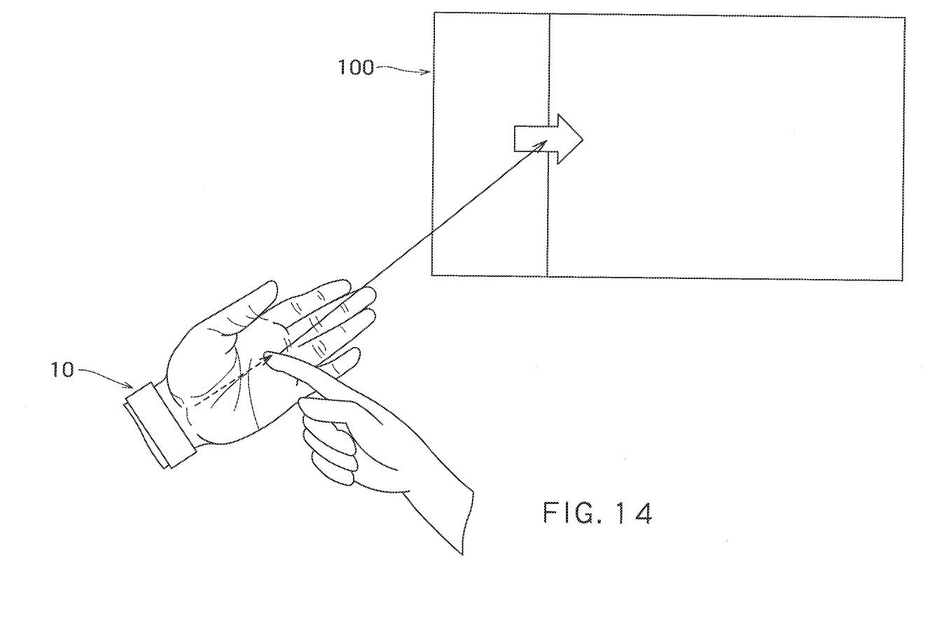

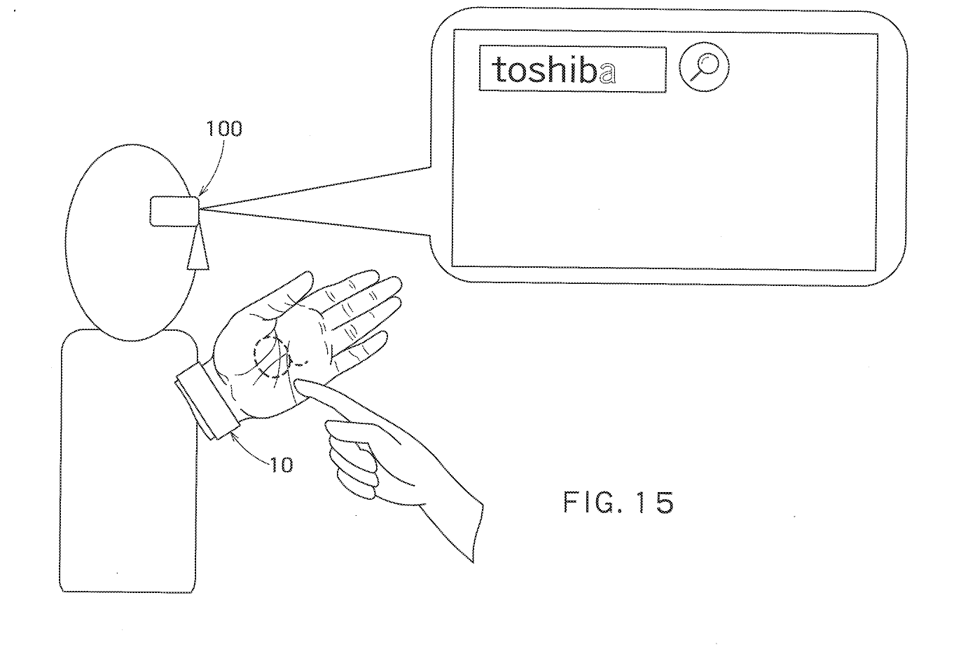

As shown in FIG. 14, the user can use the wearable information input device 10 to slide (change) display screens of an external device 100 associated with the wearable information input device 10. For example, when the user inputs a flicking action by using the wearable information input device 10, the control unit 18 generates a control signal for causing the external device 100 to execute the input flicking action, and the generated control signal is transmitted to the external device 100 via the communication unit 20. Based on the received control signal, the external device 100 executes the flicking action, to slide display screens. In a case where the external device 100 is a television receiver, the user can perform an operation such as display channel switching through a flicking action.

As shown in FIG. 15, the user can also use the wearable information input device 10 to input text information to the display screen of an eyeglass-type wearable device (external device) 100 associated with the wearable information input device 10. The user can not only input characters but also perform a gesture operation or a cursor operation.

As described above, a user can operate an external device 100 by using the wearable information input device 10 according to this embodiment. Accordingly, the user can operate an external device 100 without the use of a special input unit (such as a remote controller of a television receiver, or a mouse of a PC) of the external device 100.

### Fourth Embodiment

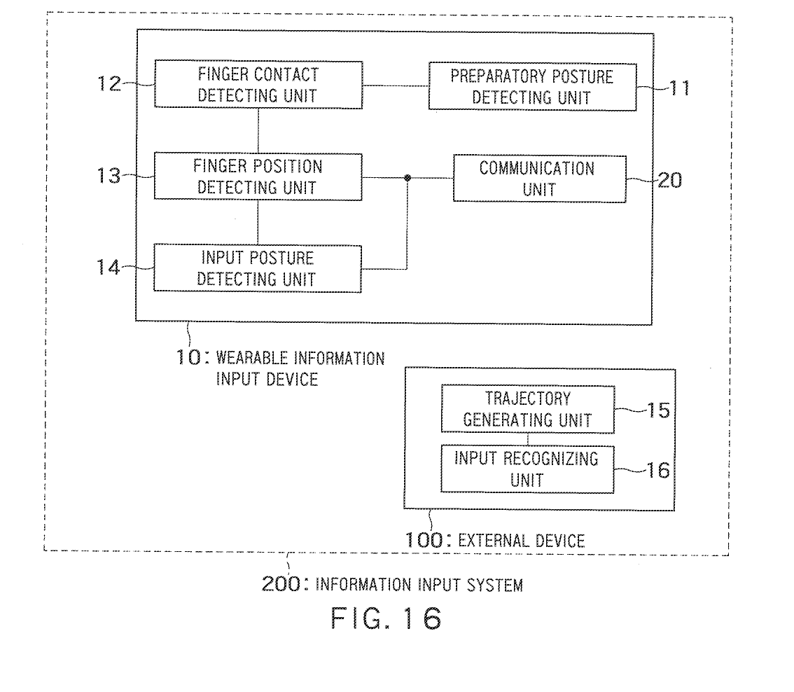

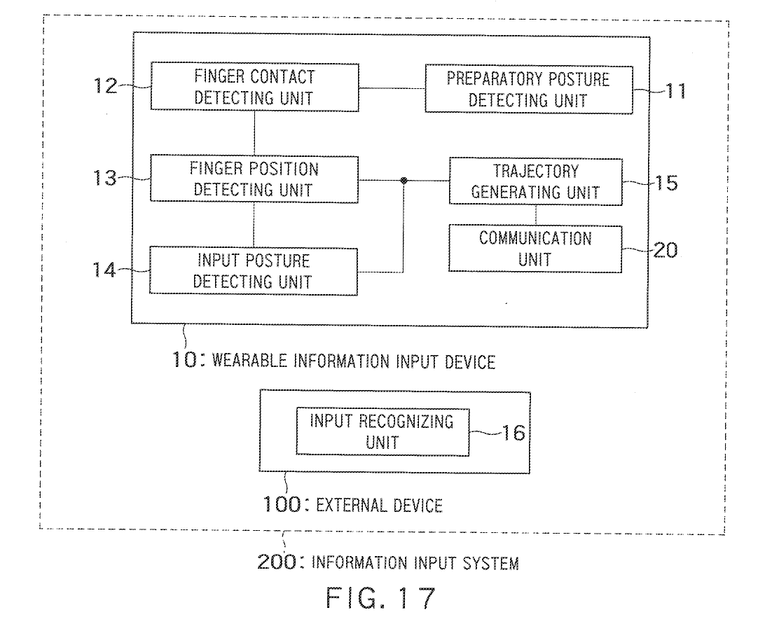

Referring now to FIGS. 16 and 17, a wearable information input device according to a fourth embodiment is described. In this embodiment, a wearable information input device and an external device constitute an information input system.

FIG. 16 is a block diagram showing the functional structure of an information input system 200. As shown in FIG. 16, the information input system 200 includes a wearable information input device 10 according to this embodiment and an external device 100 associated with the wearable information input device 10.

The wearable information input device 10 includes a preparatory posture detecting unit 11, a finger contact detecting unit 12, a finger position detecting unit 13, an input posture detecting unit 14, and a communication unit 20. The above components are the same as those of the foregoing embodiments.

The external device 100 has a communication function, and is associated with the wearable information input device 10 via the communication unit 20. The external device 100 is a PC, a television receiver, a smartphone, a tablet PC, an eyeglass-type wearable device, a digital signage device, a projector connected to a screen, or an audio device, for example. In this embodiment, the external device 100 includes a trajectory generating unit 15 and an input recognizing unit 16. The structures of the trajectory generating unit 15 and the input recognizing unit 16 are the same as those of the foregoing embodiments.

In this embodiment, when a user inputs information by using the wearable information input device 10, the finger position detecting unit 13 detects a finger position, and the input posture detecting unit 14 detects an input posture. The communication unit 20 transmits finger position information and input posture information to the trajectory generating unit 15 of the external device 100 at sampling intervals or when a finger non-contact state is detected by the finger contact detecting unit 12. When the external device 100 receives the finger position information and the input posture information, the trajectory generating unit 15 generates trajectory information based on the finger position information, and the input recognizing unit 16 recognizes input contents based on the trajectory information and the input posture information.

The external device 100 can store recognized input contents. In a case where the external device 100 includes an output means, input contents may be output form the output means. Further, the external device 100 may transmit input contents and a control signal generated in accordance with the input contents to the wearable information input device 10 or another external device.

As shown in FIG. 17, the wearable information input device 10 may include the trajectory generating unit 15, and the external device 100 may not include the trajectory generating unit 15. In this case, when the user inputs information by using the wearable information input device 10, the finger position detecting unit 13 detects a finger position, and the input posture detecting unit 14 detects an input posture. The trajectory generating unit 15 generates trajectory information based on the finger position information. The communication unit 20 transmits the trajectory information and the input posture information to the input recognizing unit 16 of the external device 100. The communication unit 20 transmits the trajectory information when the finger contact detecting unit 12 detects a finger non-contact state of the user, for example. Also, the communication unit 20 may transmit the input posture information at sampling intervals, or may collectively transmit the input posture information of a predetermined period stored in the input posture detecting unit 14 when transmitting the trajectory information. When the external device 100 receives the trajectory information and the input posture information, the input recognizing unit 16 recognizes input contents.

As described above, the wearable information input device 10 according to this embodiment does not include the input recognizing unit 16, but the external device 100 includes the input recognizing unit 16. Accordingly, the input contents recognition method of a user can be updated by updating the input recognizing unit 16 included in the external device 100, without any change being made to the wearable information input device 10. For example, when the recognition method in the input recognizing unit 16 is updated to enable new gesture recognition, the user can use a new gesture operation, without making any change to the wearable information input device 10.

### Fifth Embodiment

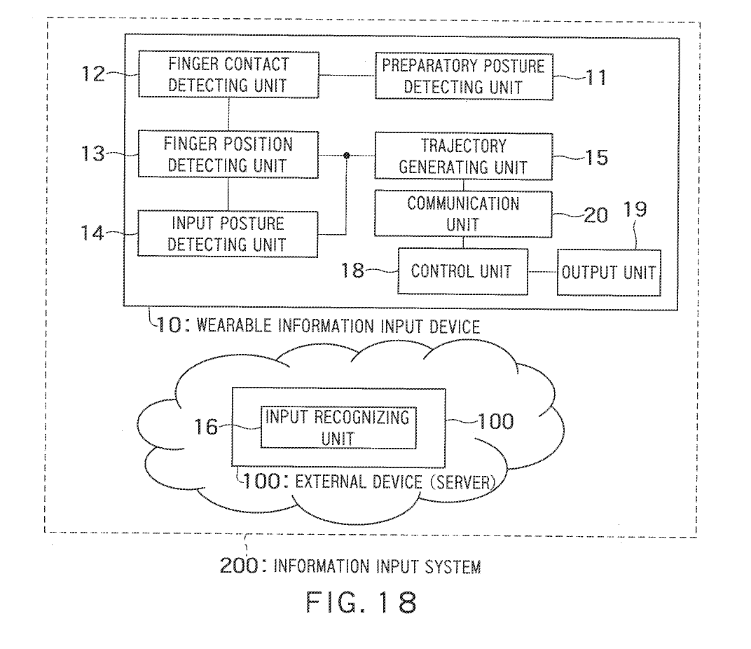

Referring now to FIG. 18, a wearable information input device according to a fifth embodiment is described. In this embodiment, the wearable information input device and a server on the Internet constitute an information input system.

FIG. 18 is a block diagram showing the functional structure of an information input system 200. As shown in FIG. 18, the information input system 200 includes a wearable information input device 10 and a server 100 associated with the wearable information input device 10.

The wearable information input device 10 includes a preparatory posture detecting unit 11, a finger contact detecting unit 12, a finger position detecting unit 13, an input posture detecting unit 14, a trajectory generating unit 15, a control unit 18, an output unit 19, and a communication unit 20. The above components are the same as those of the foregoing embodiments.

The server 100 is an external device that is provided on the Internet, and is associated with the wearable information input device 10 via the communication unit 20. The server 100 includes an input recognizing unit 16. The structure of the input recognizing unit 16 is the same as that of the foregoing embodiments.

In this embodiment, when a user inputs information by using the wearable information input device 10, the finger position detecting unit 13 detects a finger position, and the input posture detecting unit 14 detects an input posture. The trajectory generating unit 15 generates trajectory information based on the finger position information. The communication unit 20 is connected to the Internet through a cellular phone network or via a Wi-Fi router, and transmits the trajectory information and the input posture information to the server 100.

The communication unit 20 transmits the trajectory information when the finger contact detecting unit 12 detects a finger non-contact state of the user, for example. Also, the communication unit 20 may transmit the input posture information at sampling intervals, or may collectively transmit the input posture information of a predetermined period stored in the input posture detecting unit 14 when transmitting the trajectory information. When the server 100 receives the trajectory information and the input posture information, the input recognizing unit 16 recognizes input contents.

In the information input system 200, the wearable information input device 10 may not include the trajectory generating unit 15, and the server 100 may include the trajectory generating unit 15, as in the fourth embodiment illustrated in FIG. 16.

As described above, the wearable information input device 10 according to this embodiment does not include the input recognizing unit 16, but the server 100 on the Internet includes the input recognizing unit 16. Accordingly, more than one user can use the input recognizing unit 16 at the same time, and the input contents recognition methods of the users can be collectively updated by updating the input recognizing unit 16 included in the server 100, without any change being made to the wearable information input device 10.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A wearable information input device worn on an upper limb of a user, the device comprising:
a contact detecting unit configured to detect contact with the upper limb by an input unit, the input unit being used by the user to input information;
a position detecting unit configured to detect a position of the input unit while the input unit is in contact with the upper limb; and
a trajectory generating unit configured to generate a trajectory of motion of the input unit based on information about the position detected by the position detecting unit.

2. The device according to claim 1, further comprising an input recognizing unit configured to recognize input contents based on information about the trajectory generated by the trajectory generating unit.

3. The device according to claim 1, wherein the input contents include at least one of a gesture, a character, a click, and a cursor movement.

4. The device according to claim 1, wherein the contact detecting unit detects contact based on a change in capacitance of the user when the input unit contacts with the upper limb.

5. The device according to claim 1, wherein the position detecting unit includes at least two light emitting devices arranged at a predetermined interval, and a light receiving device receiving light emitted from the light emitting devices and reflected by the input unit, and detects the position of the input unit based on the light received by the light receiving device.

6. The device according to claim 2, further comprising an input posture detecting unit configured to detect an input posture, the input posture being a posture of the upper limb while the input unit is in contact with the upper limb,
wherein the input recognizing unit recognizes the input contents based on the input posture detected by the input posture detecting unit.

7. The device according to claim 1, further comprising a preparatory posture detecting unit configured to detect a preparatory posture, the preparatory posture being a posture of the upper limb when the user inputs information,
wherein the contact detecting unit detects contact of the input unit while the preparatory posture is detected by the preparatory posture detecting unit.

8. The device according to claim 6, wherein the input posture detecting unit includes an acceleration sensor, and detects the input posture based on a value measured by the acceleration sensor.

9. The device according to claim 7, wherein the preparatory posture detecting unit includes an acceleration sensor, and detects the preparatory posture based on a value measured by the acceleration sensor.

10. The device according to claim 2, further comprising a storage unit configured to store the input contents recognized by the input recognizing unit.

11. The device according to claim 2, further comprising a control unit configured to generate a control signal in accordance with the input contents recognized by the input recognizing unit.

12. The device according to claim 11, further comprising the output unit configured to output in accordance with the control signal generated by the control unit.

13. The device according to claim 2, further comprising:
a control unit configured to generate a control signal for an external device in accordance with the input contents recognized by the input recognizing unit; and
a communication unit configured to transmit the control signal generated by the control unit to the external device.

14. The device according to claim 1, wherein the input unit is a part of another upper limb of the user.

15. An information input system comprising:
a wearable information input device worn on an upper limb of a user, the device including:
a contact detecting unit configured to detect contact with the upper limb by an input unit, the input unit being used by the user to input information;
a position detecting unit configured to detect a position of the input unit while the input unit is in contact with the upper limb; and
a communication unit configured to transmit information about the position detected by the position detecting unit; and
an external device including an input recognizing unit configured to recognize input contents based on the information about the position transmitted from the communication unit.

16. The system according to claim 15, wherein the device further includes a trajectory generating unit configured to generate a trajectory of motion of the input unit based on the information about the position detected by the position detecting unit, the communication unit transmits information about the trajectory generated by the trajectory generating unit, and the external device recognizes the input contents based on the information about the trajectory transmitted from the communication unit.

17. The system according to claim 14, wherein the external device is a server on the Internet.

18. An information input method using a wearable information input device worn on an upper limb of a user, the method comprising:
detecting contact with the upper limb by an input unit, the input unit being used by the user to input information;
detecting a position of the input unit while the input unit is in contact with the upper limb;
generating a trajectory of motion of the input unit based on information about the detected position; and
recognizing input contents based on the generated trajectory.
